(19) United States
(12) Patent Application Publication
(10) Pub. No.: US 2026/0235555 A1
(43) Pub. Date: Aug. 13, 2026

(54) FOOD PROCESSING TESTING DEVICE AND METHOD

(71) Applicant: CHIA-HUNG CHEN, New Taipei (TW)

(72) Inventors: CHIA-HUNG CHEN, New Taipei (TW); CHIA-CHI SU, Taichung (TW)

(21) Appl. No.: 19/156,549

(22) PCT Filed: Feb. 7, 2024
(86) PCT No.: PCT/CN2024/076533

§ 371 Date: Aug. 14, 2025

Related U.S. Application Data
(60) Provisional application No. 63/445,732, filed on Feb. 15, 2023.

(51) Int. Cl. G01N 29/06; G01N 29/44

(52) U.S. Cl. CPC G01N 29/0654; G01N 29/4481; G01N 2291/02466

(57) ABSTRACT

A food processing testing device and method. The testing device comprises: a testing apparatus (1), which emits an acoustic wave signal to a food under test, and receives a piece of energy information of at least one corresponding reflected acoustic wave signal after the acoustic wave signal passes through said food; an operation processing module (2), which is in signal connection with the testing apparatus (1), and is used for performing an operation on the energy information and generating a testing result; and a conduction structure (3), which is arranged on a side surface of said food and between said food and the testing apparatus (1), and is used for transferring the acoustic wave signal and the at least one reflected acoustic wave signal. By means of the testing method, the actual aging situation of a food under test is obtained, thereby improving the stability of the aging quality.

### FIELD OF THE INVENTION

The present invention relates to a testing field, particularly relating to a food processing testing device and a testing method thereof.

### BACKGROUND OF THE INVENTION

Food aging is a processing method commonly applied to food products, particularly meat and dairy products. The aging process can be broadly categorized into dry aging, wet aging, and lactic acid fermentation. Among them, dry aging is a method primarily used for meat, especially beef. In a typical dry aging process, cuts of meat are suspended in a controlled environment with low temperature and specific humidity conditions (generally 60%-80%, although certain processing techniques may vary) for a period of several weeks to months. During this time, endogenous enzymes within the meat promote aging (some processes claim a role for microorganisms, although this is a subject of ongoing debate). During dry aging, a hard outer crust forms on the surface of the meat. The physical and mechanical properties of this crust trigger the release of additional enzymes from the meat, thereby accelerating the breakdown of internal tissue proteins. As a result of enzymatic hydrolysis, meat proteins are degraded into peptides and amino acids, the perimysium is disrupted, and the muscle fibers become less prone to contraction upon heating. This leads to a more tender texture upon cooking. Additionally, the increased presence of amino acids enhances the flavor intensity of the meat. In contrast, “wet aging” is another common method wherein the meat is vacuum-sealed in plastic packaging and stored at low temperatures for several days to weeks. The aging process is also driven by the meat's natural enzymes, resulting in a tender and juicy final product.

The difference between dry aging and wet aging lies in the exposure of the meat to air. In dry aging, moisture evaporates from the outer layers of the beef, allowing the surface fat and outer tissue to dry out. This helps retain moisture in the inner portion, preserving the texture of the meat. Moreover, the marbling tends to become more concentrated, which contributes to enhanced flavor. However, dry aging is associated with high product loss. After aging, the dried and hardened outer layers are not suitable for consumption and must be trimmed off, often leaving less than 70% of the original cut usable for cooking. Moreover, the process relies heavily on the subjective experience and judgment of skilled personnel, leading to high production costs.

In conventional dry aging processes, the required aging time may vary due to differences in the thickness and quality of individual meat cuts. Determining whether a piece of meat has reached the ideal level of aging typically requires assessment by skilled personnel. Evaluation criteria include appearance, texture, and smell. A traditional method of sampling involves inserting a bamboo stick into the meat to assess its internal characteristics based on color, odor, and texture. This method places significant demands on the evaluator's experience and introduces a high degree of subjectivity. Consequently, different evaluators may arrive at inconsistent judgments regarding the quality of aged meat, making it difficult to ensure consistent quality control. Furthermore, traditional sampling methods may result in physical damage to the meat, potentially compromising the aging process and causing product loss. These factors collectively contribute to the high cost of dry aging.

In light of this, the present invention provides a food processing testing device and a testing method thereof. The aging status can be quantitatively assessed, thereby introducing a more objective insight of the aging status. The aging quality can be more precisely monitored so that product loss will be minimized, which reduces production cost.

### SUMMARY OF THE INVENTION

One purpose of the present invention primarily lies in providing a food processing testing device, the internal tissue status of a food under test is obtained by using a testing apparatus, and a testing result of real-time aging status is obtained by using an operation processing module, thereby effectively monitoring aging quality.

Another purpose of the present invention lies in providing a food processing testing device, the food under test is penetrated by an acoustic wave signal, and a testing result is generated by processing an energy distribution of the reflected acoustic wave signal, thereby effectively enhance success rate and quality of aging.

To serve one of the purposes as addressed hereinabove, one embodiment of the present invention provides a food processing testing device, comprising: a testing apparatus emitting an acoustic wave signal to a food under test, and receiving an energy information of at least one corresponding reflected acoustic wave signal after the acoustic wave signal passes through the food under test; an operation processing module, being signally connected with the testing apparatus, and configured to perform an operation processing on the energy information so as to generate a testing result; and a conduction structure, being arranged on a side surface of the food under test and disposed between the food under test and the testing apparatus, wherein the conduction structure is configured to transfer the acoustic wave signal and the at least one reflected acoustic wave signal.

Preferably, the testing apparatus is selected from an ultrasonic imaging device.

Preferably, the conduction structure comprises an insulating layer and a gel layer; the insulating layer is made of a material selected from a group consisting of polyethylene (PE), polyvinyl chloride (PVC), polyvinylidene chloride (PCDC) and polymethylpentene (PMP) and a combination thereof, and the gel layer is made of material selected from a group consisting of water, glycerol, gelatin or a combination thereof.

Preferably, the conduction structure comprises a liquid layer disposed between the insulating layer and the gel layer, and the liquid layer is selected from water.

Preferably, the food processing testing device further comprises an adjustment device, being disposed on another side surface of the food under test, configured to adjust the energy information of the at least one corresponding reflected acoustic wave signal, wherein the adjustment device is selected from a group consisting of a metal piece in a curve form, an acoustic wave-reflecting material in a curve form, convex lens, concave lens, double concave lens, double convex lens, array lens, spherical lens, Fresnel lens and a combination thereof.

Preferably, the food under test is selected from an aged meat, seafood, cheese and a combination thereof.

To serve the other purpose as addressed above, one embodiment of the present invention provides a food processing testing method, comprising steps of: emitting an acoustic wave signal to a food under test by using a testing apparatus; reflecting an energy information of at least one corresponding reflected acoustic wave signal after the acoustic wave signal passes through the food under test; and performing an operation processing on a distribution of the energy information so as to generate a testing result.

Preferably, at the step of performing the operation processing on the distribution of the energy information so as to generate the testing result, the energy information is transformed to be a gray-scale image, and the operation processing is performed based on a plurality of gray-scale values of the gray-scale image so as to generate the testing result, wherein the testing result comprises an aging status.

Preferably, at the step of performing the operation processing on the distribution of the energy information so as to generate the testing result, the energy information, the testing result and an information of the food under test are processed by an artificial intelligence so that a predictive aging information is generated.

Preferably, the predictive aging information comprises an aging temperature value, an aging humidity value, an aging time, an air flowrate or a combination thereof.

The present invention allows rapid and precise testing of actual aging status, and data of the actual aging status can be harvested by artificial intelligence so that optimal aging condition and duration is predicted. By this means, consistency of aging quality is significantly enhanced, and production cost as well as loss is reduced.

### BRIEF DESCRIPTION OF THE DRAWINGS

FIG. 1A is a schematic illustration of the device in one embodiment of the present invention;

FIG. 1B is a schematic illustration of the conduction structure in one embodiment of the present invention;

FIG. 2A is a schematic illustration of the device in operation in one embodiment of the present invention;

FIG. 2B presents testing image results by using different types of adjustment device in one embodiment of the present invention;

FIG. 3 is a flowchart illustrating the method in one embodiment of the present invention;

FIG. 4A presents an exemplary image under operation processing in one embodiment of the present invention;

FIG. 4B presents an exemplary image under operation processing in one embodiment of the present invention;

FIG. 5A presents an image of crust in one embodiment of the present invention;

FIG. 5B presents a hollowed-out image of a muscle tissue in one embodiment of the present invention;

FIG. 6A presents one exemplary image under testing in one embodiment of the present invention;

FIG. 6B presents another exemplary image under testing in one embodiment of the present invention;

FIG. 6C presents one another exemplary image under testing in one embodiment of the present invention;

FIG. 7A presents one image under actual testing in one embodiment of the present invention;

FIG. 7B presents another image under actual testing in one embodiment of the present invention;

FIG. 7C presents one another image under actual testing in one embodiment of the present invention;

FIG. 7D presents still one another image under actual testing in one embodiment of the present invention; and

FIG. 8 is a figure illustrating data analysis in one embodiment of the present invention.

### DETAILED DESCRIPTION OF THE INVENTION

In order to make the above and/or other objects, advantages, and features of the present invention more apparent and understandable, preferred embodiments are exemplified and described in detail below.

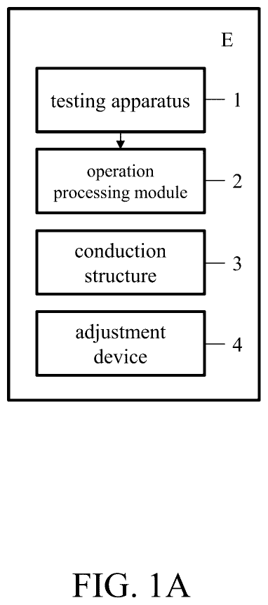

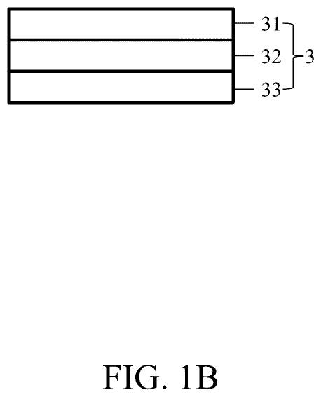

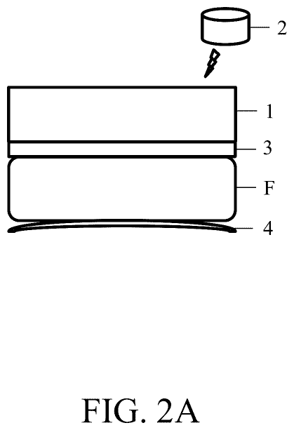

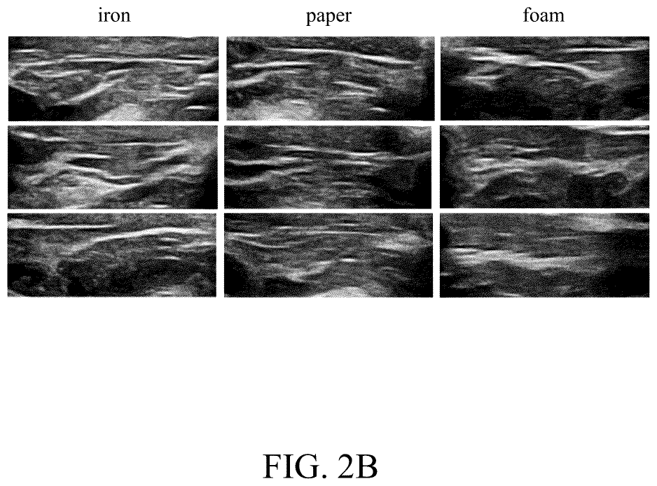

Please refer to FIGS. 1A, 1B and 2A presenting schematic illustrations of the device, conduction structure and device in operation in one embodiment of the present invention. As shown in the figures, disclosed in one embodiment of the present invention is a food processing testing device (E), comprising: a testing apparatus (1), an operation processing module (2), a conduction structure (3) and an adjustment device (4), wherein the testing apparatus (1) is signally connected to the operation processing module (2), and a working mechanism thereof is detailed below:

The testing apparatus (1) is configured to emit an acoustic wave signal to a food under test (F). When the acoustic wave signal passes through the food under test (F) and contacts a tissue junction between tissue portions of different densities inside the food under test (F), a portion of the acoustic wave signal is reflected. By this, the testing apparatus (1) receives an energy information of at least one corresponding reflected acoustic wave signal after the acoustic wave signal passes through the food under test (F); in one embodiment, the testing apparatus (1) is selected from an ultrasonic imaging device. Furthermore, the acoustic wave signal may be acoustic wave of ultra-high frequency, and the frequency may primarily range from 1 MHz to 15 MHz, but not limited to this.

In one embodiment, the food under test (F) may be a meat under aging, a seafood under aging, a cheese under aging or a combination thereof, preferably food including a dry-aged beef, a fish salted and dried overnight, a cheese or a ham, but not limited to this.

The operation processing module (2) is configured to perform an operation processing of the energy information so as to generate a testing result. The testing result may be an aging status at different positions on the food under test (F). In other words, the testing result may present a distribution of aging status at every portion of the food under test (F).

The conduction structure (3) is arranged on a side surface of the food under test (F) and disposed between the food under test (F) and the testing apparatus (1). The conduction structure (3) is configured to transfer the acoustic wave signal and the at least one reflected acoustic wave signal. In one example, as shown in FIG. 1B, the conduction structure (3) comprises an insulating layer (31) and a gel layer (32). The insulating layer (31) may be made of a material selected from a group consisting of polyethylene (PE), polyvinyl Chloride (PVC), polyvinylidene Chloride (PCDC) and polymethylpentene (PMP) and a combination thereof. On the other hand, the gel layer (32) may be made of a material selected from a group consisting of water, glycerol, gelatin or a combination thereof. Additionally, a number of the gel layer (32) is not limited.

In one preferred embodiment, the conduction structure (3) may further comprise a liquid layer (33), where the liquid layer (33) is disposed between the insulating layer (31) and the gel layer (32). The liquid layer (33) is selected from water, but not limited to this.

In one embodiment, to avoid intensity loss or noise interference during transferring of the acoustic wave signal, the food processing testing device is further configured of an adjustment device (4). The adjustment device (4) is disposed on the other side surface of the food under test (F). In particular, the food under test (F) is disposed between the adjustment device (4) and the conduction structure (3), and being configured to adjust the energy information of the at least one corresponding reflected acoustic wave signal. The energy information comprises an energy intensity and a depth information of a position where the acoustic wave signal is reflected. The energy information is determined according to an energy magnitude and time of reflection. The condition varies with tissue densities and the transferring status of the acoustic wave signal inside the tissue. The energy information may be adjusted, according to demands, by using the adjustment device (4) so as to increase or lower the reflected energy of the reflected acoustic wave signal, thereby producing more accurate testing results.

In one embodiment, the adjustment device (4) is selected from a group consisting of a metal piece in a curve form, an acoustic wave-reflecting material in a curve form, convex lens, concave lens, double concave lens, double convex lens, array lens, spherical lens, Fresnel lens and a combination thereof, wherein the metal piece may be made of iron, copper, titanium, stainless steel, aluminum alloy or a combination thereof, while any material applicable for acoustic energy adjustment may be included.

Shown in FIG. 2B are testing image results by using different types of adjustment device (4) in one embodiment, and the materials of the adjustment device (4) are iron, paper, and foam (from left to right), respectively. The operation frequency of the acoustic wave signal is 7.1 MHz, scanning depth is 7.1 cm, and contrast enhancement is 60. The data can be found in Table 1.

TABLE 1
testing data by using different
types of adjustment device (4)

| | Gray-scale | |
|---|---|---|
| Material | value (Ave.) | Resolution |
| iron | 84.48 | 35,880 |
| paper | 69.53 | 35,800 |
| foam | 60.96 | 36,600 |

It can be clearly inferred from Table 1 and FIG. 2B, acoustic energy varies with materials of the adjustment device (4). Among these materials, metal outperforms the rest materials. Thus, material suitable for the adjustment device (4) may be selected according to the need of operation processing so as to effectively improve testing accuracy.

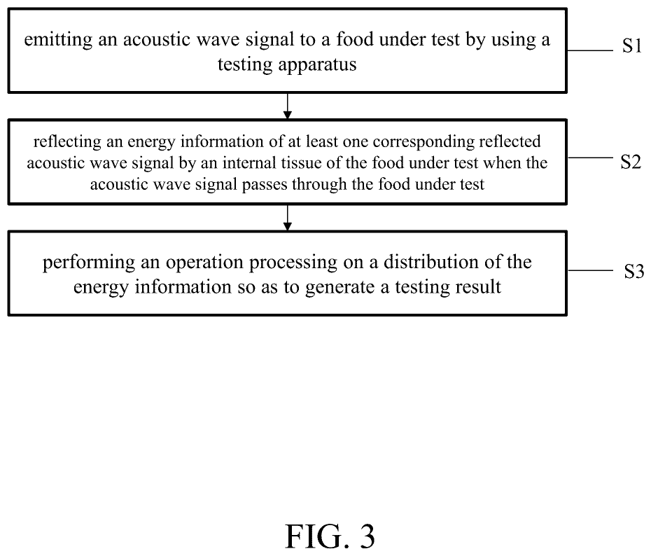

Shown in FIG. 3 is a flowchart illustrating the method in one embodiment, and the method comprises steps of:
Step S1: emitting an acoustic wave signal to a food under test by using a testing apparatus;
Step S2: reflecting an energy information of at least one corresponding reflected acoustic wave signal by an internal tissue of the food under test when the acoustic wave signal passes through the food under test; and
Step S3: performing an operation processing on a distribution of the energy information so as to generate a testing result.

As shown in the step S1, the acoustic wave signal is emitted from the testing apparatus (1) to one side surface of the food under test (F), wherein the food under test (F) may be an aging meat, seafood, cheese, or a combination thereof. In addition, the frequency of the acoustic wave signal primarily ranges from 1 MHz to 15 MHz.

As shown in the step S2, after the acoustic wave signal penetrates the food under test (F), the energy information of the at least one reflected acoustic wave signal is reflected from internal tissue with various densities. The energy information may be presented in a gray-scale contrast image, wherein the intensity of the gray-scale image depends on energy magnitude of the reflected acoustic wave. As the energy magnitude is larger, a brighter pixel is produced in the image. On the contrary, as the energy magnitude is smaller, a darker pixel is produced in the image. For instance, tissue with higher water content is more conductive for ultrasonic wave, and less reflected acoustic wave signal is reflected. Thus, with no echo, a black image is presented. In contrast, tissue with less water content reflects more reflected acoustic wave signal, thereby a low echo image or an equal echo image with grayish color is presented.

As indicated in step S3, an operation processing is performed with the energy information obtained at the previous one step so as to generate the testing result, where the testing result may be a classification according to aging status, but not limited to this.

In one embodiment, the operation processing includes a transformation of the energy information to a gray-scale image, and a computation based on a plurality of gray-scale values of the gray-scale image. Preferably, a mean value is output by calculation based on the plurality of gray-scale values in a specified region of interest (ROI) so as to generate the testing result.

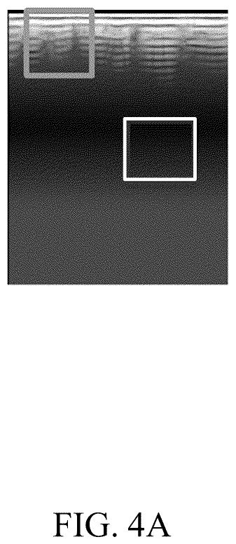

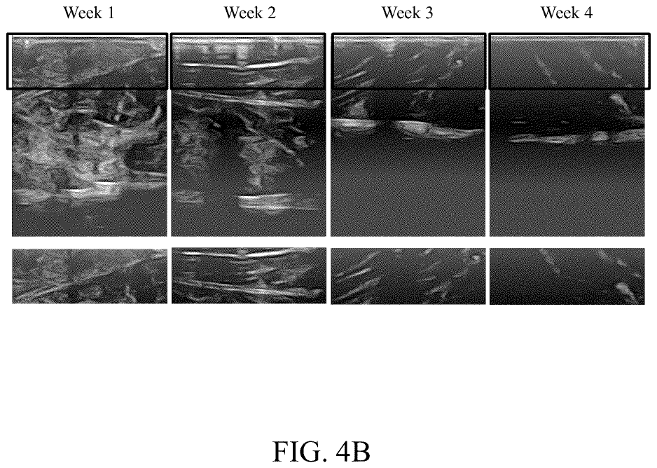

Presented in FIGS. 4A to 4B are exemplary images under operation processing in one embodiment. As indicated, the operation processing may be initiated in an ROI at the upper-left corner of the gray-scale image to determine whether the device correctly contacts with the food under test (F). When correct contacting is confirmed, the operation processing is further performed in another ROI at a lower-right corner. For instance, the gray-scale values range from 0~255, and a mean value is calculated according to the gray-scale values in this ROI. Alternatively, the mean value may be calculated according to the gray-scale values in multiple ROIs. Consequently, the aging status is determined by matching the mean value with a default gray-scale value depending on intrinsic properties of the food under test (F).

In one exemplary embodiment, taking the testing results of an aged beef, as shown in FIG. 4B, the testing results are obtained by performing test once every week, totally 4 tests, during aging process. In the upper frames are ROIs confirmed with correct contacting, and the mean values of these ROIs are calculated according thereto, where the processed data can be found in Table 2.

TABLE 2
processed data of the ROIs

| | Mean | Mean |
|---|---|---|
| | gray-scale | pixel |
| Week | value | value |
| 1 | 51.92 | 99,882 |
| 2 | 60.97 | 100,240 |
| 3 | 73.10 | 99,120 |
| 4 | 83.45 | 102,483 |

As indicated in Table 2, it could be clearly inferred that the mean gray-scale values in ROIs vary at different aging status, thereby rendering the mean gray-scale value a reference for determination of aging status, but not limited to this.

In one embodiment, an artificial intelligence may be applied to process the energy information, testing result and information of the food under test so as to generate a predictive aging information. As quality of each food under test (F) varies, an aging temperature value, an aging humidity value, an aging time and an air flowrate would be adjusted according to the specific characteristics of the respective food under test (F). With this regard, the artificial intelligence may be introduced to determine an optimal aging information corresponding to each food under test (F). Preferably, the information of the food under test may be information regarding meat cut, marbling level, aging chamber or aging bag in use. A classification training process may be performed with the information of the food under test so that a model outputting more precise judgement is established.

Detailed embodiments of the present invention are further illustrated below with reference to several examples:

During a beef dry-aging process, cells are degraded into amino acids. Accordingly, the food processing testing device is used for revealing aging status at each stage, and optimal aging temperature, aging humidity, aging time and aging air flowrate can be deduced based on the aging status, thereby realizing precise monitoring and control of aging quality.

A US choice grade pan-seared tenderloin is exemplified hereinafter, where the weight is 3,050 g and aging time is 47 days. The weight is measured every week during dry-aging process, and weight data from week 1 to 8 are listed in Table 3.

TABLE 3
weight data of US choice
grade pan-seared tenderloin

| | | dehydration- |
|---|---|---|
| Date | | induced |
| of | Weight | weight loss |
| test | (g) | ratio (%) |
| 4/19 | 3,050 | 100 |
| 4/26 | 2,873 | 94 |
| 5/3 | 2,761 | 91 |
| 5/10 | 2,657 | 87 |
| 5/17 | 2,591 | 85 |
| 5/24 | 2,524 | 83 |
| 5/31 | 2,473 | 81 |
| 6/4 | 2,443 | 80 |

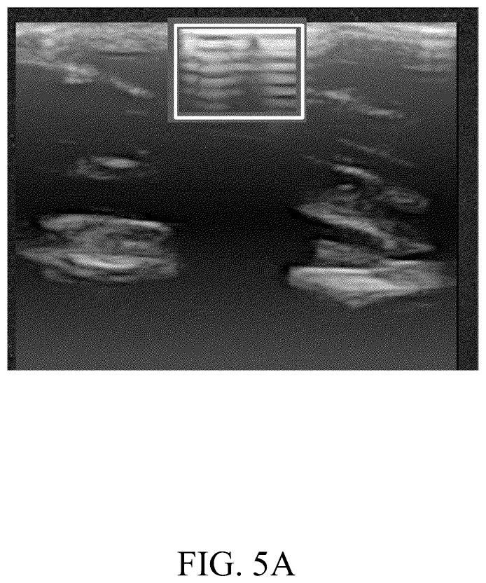

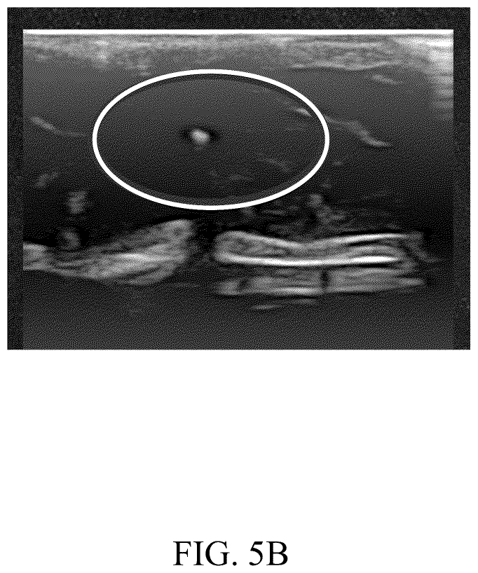

FIGS. 5A to 5B present an image of a crust and a hollowed-out image of muscle tissue in one example. In this example, an ultrasonic imaging device is used as the testing apparatus. As the outermost layer of the beef cut would be gradually dried and becomes a crust (as shown in the framed region) during dry-aging process, the crust would minimize microbial contamination in the internal portion of the beef cut. Also, the crust avoids dehydration in the internal portion of the beef cut, and maintains the internal moisture to a certain level so that enzymatic hydrolysis continuously drives the aging process. With continuous enzymatic hydrolysis of the muscle tissue, dense flavors are produced by degradation of muscle bundles, sarcolemma and proteins into amino acids and peptides. These degradation leads to continuous hollowing-out of the muscle tissue image. With this regard, the aging status can be deduced out according to testing results from different time points.

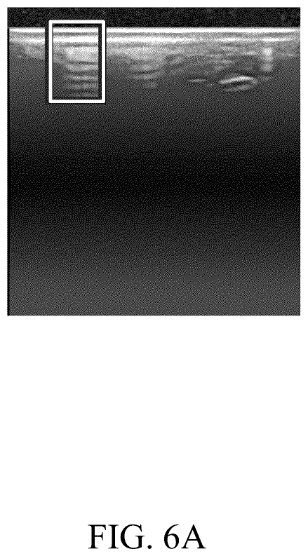

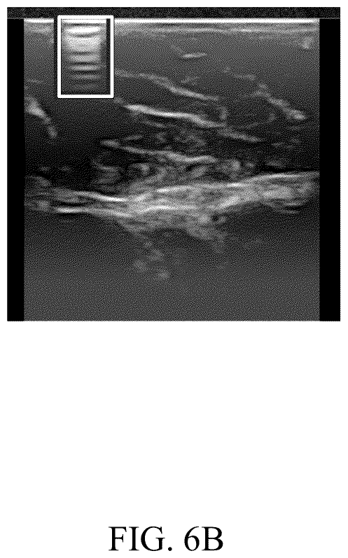

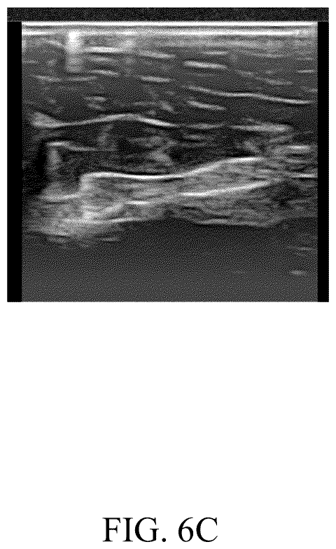

Images with energy information distribution extracted at each test are imported into a two-stage operation processing. In the first stage, a blurring level of each image with energy information distribution extracted is determined. FIGS. 6A to 6C present exemplary images under testing. As shown in FIG. 6A, the framed region indicates one example of incorrect contacting of the testing apparatus with beef cut. As shown in FIG. 6B, the framed region indicates one example of partially incorrect contacting of the testing apparatus with beef cut. As shown in FIG. 6C, the framed region indicates one example of completely correct contacting of the testing apparatus with beef cut. Accordingly, those images exhibiting conditions matching FIG. 6A or FIG. 6B are excluded. The rest images are then imported for artificial intelligence identification to conduct inference of aging status based on crust thickness and tissue morphology beneath thereof.

Workflow: firstly, the beef cut is wiped and dried after rinse, and put in an aging bag before sealed with a seal clip. The beef cut undergoes 3 tests per week. The aging status is classified into 4 grades: grade 1 refers to aging status less than 30%; grade 2 refers to aging status between 30% to 60%; grade 3 refers to aging status between 60% to 90%; and grade 4 refers to aging status larger than 90%. The aging status may vary with demands, and not limited to this.

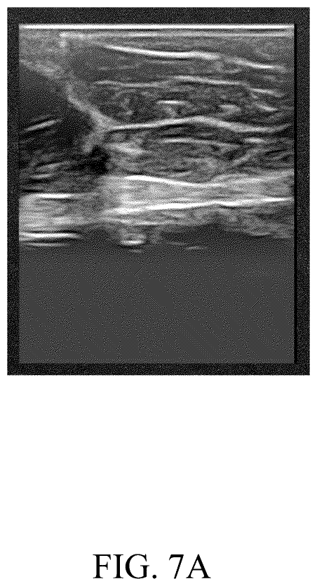

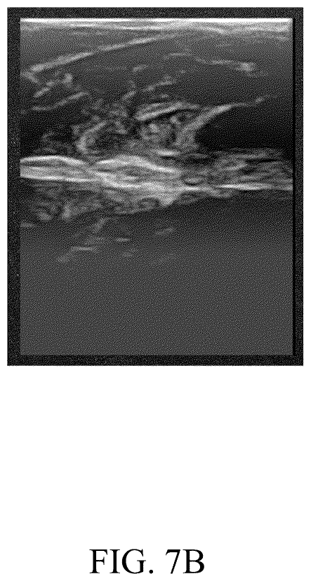

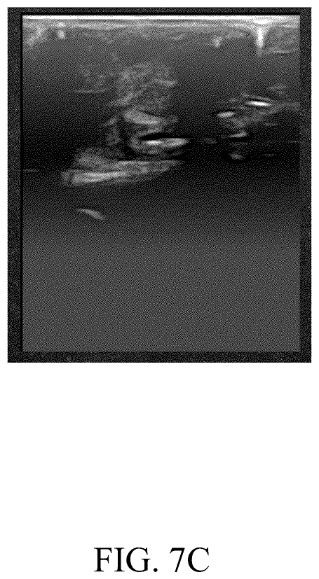

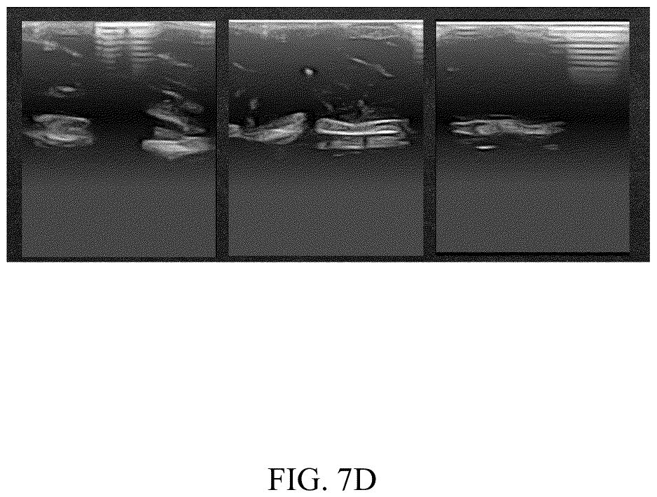

FIGS. 7A to 7D present images under actual testing. As indicated, FIG. 7A presents aging status of grade 1, FIG. 7B presents aging status of grade 2, FIG. 7C presents aging status of grade 3, and FIG. 7D presents aging status of grade 4. Additionally, results after artificial intelligence identification training are listed in Table 4-1, Table 4-2 and Table 4-3.

TABLE 4-1
the training results for classification
using two groups as target labels

| | | | Averaged | Number |
|---|---|---|---|---|
| Target | | | precision | of |
| labels | Precision | Recall | (A.P.) | images |
| Grade 1 | 98.7% | 97.4% | 99.9% | 385 |
| Grade 4 | 96.2% | 98.0% | 99.7% | 254 |

TABLE 4-2
the training results for classification
using three groups as target labels

| | | | Averaged | Number |
|---|---|---|---|---|
| Target | | | precision | of |
| labels | Precision | Recall | (A.P.) | images |
| Grade 1 | 97.4% | 96.1% | 99.9% | 385 |
| Grade 4 | 84.3% | 84.3% | 92.5% | 254 |
| Incorrect | 91.3% | 92.6% | 94.9% | 339 |
| contact | | | | |

TABLE 4-3
the training results for classification
using five groups as target labels

| | | | Averaged | Number |
|---|---|---|---|---|
| Target | | | precision | of |
| labels | Precision | Recall | (A.P.) | images |
| Grade 1 | 95.9% | 90.9% | 98.7% | 385 |
| Grade 2 | 88.5% | 90.1% | 94.1% | 553 |
| Grade 3 | 84.9% | 83.2% | 90.5% | 473 |
| Grade 4 | 80.4% | 80.4% | 84.7% | 254 |
| Incorrect | 90.8% | 90.0% | 94.9% | 597 |
| contact | | | | |

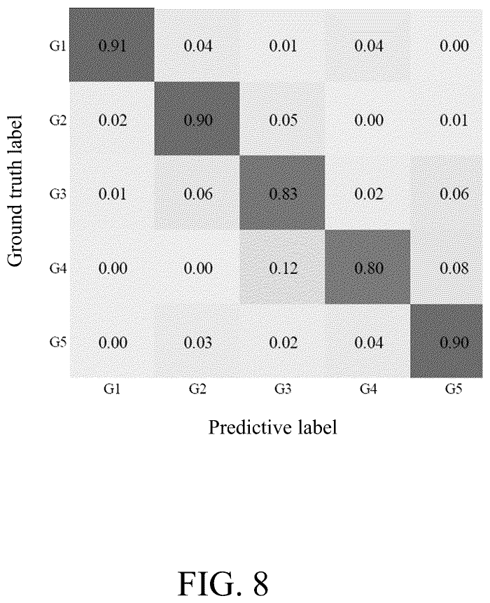

Shown in FIG. 8 is a figure illustrating the data analysis using confusion matrix incorporated in the artificial intelligence model, which are also indicators for performance evaluation of classification. Among all the indicators, G1 refers to grade 1, G2 refers to grade 2, G3 refers to grade 3, G4 refers to grade 4, and G5 refers to incorrect contact with the device. With reference to the data chart, it can be clearly inferred that the food processing testing device in this example exhibits good performance in classification, favorable for implementation of the present invention.

In sum, the present invention provides a food processing testing device and a testing method, where the testing device obtains internal tissue status of the food under test by transferring of an acoustic wave signal. The energy information of the reflected acoustic wave signal is further processed to produce a testing result of actual aging status. By using the device, effective monitoring and control of aging quality can be realized, achieving the purpose of the present invention.

The above description is merely illustrative of preferred embodiments of the present invention. It should be noted that various modifications and refinements may be made by those skilled in the art without departing from the spirit and scope of the invention. Such modifications and refinements shall also be regarded as falling within the scope of the present invention.

1. A food processing testing device, comprising:
a testing apparatus emitting an acoustic wave signal to a food under test, and receiving an energy information of at least one corresponding reflected acoustic wave signal after the acoustic wave signal passes through the food under test;
an operation processing module, being signally connected with the testing apparatus, and configured to perform an operation processing on the energy information so as to generate a testing result; and
a conduction structure, being arranged on a side surface of the food under test and disposed between the food under test and the testing apparatus, wherein the conduction structure is configured to transfer the acoustic wave signal and the at least one reflected acoustic wave signal.

2. The food processing testing device according to claim 1, wherein the testing apparatus is selected from an ultrasonic imaging device.

3. The food processing testing device according to claim 1, wherein the conduction structure comprises an insulating layer and a gel layer; the insulating layer is made of a material selected from a group consisting of polyethylene (PE), polyvinyl chloride (PVC), polyvinylidene chloride (PVDC) and polymethylpentene (PMP) and a combination thereof, and the gel layer is made of material selected from a group consisting of water, glycerol, gelatin or a combination thereof.

4. The food processing testing device according to claim 3, wherein the conduction structure comprises a liquid layer disposed between the insulating layer and the gel layer, and the liquid layer is selected from water.

5. The food processing testing device according to claim 1, further comprising an adjustment device, being disposed on another side surface of the food under test, configured to adjust the energy information of the at least one corresponding reflected acoustic wave signal, wherein the adjustment device is selected from a group consisting of a metal piece in a curve form, an acoustic wave-reflecting material in a curve form, convex lens, concave lens, double concave lens, double convex lens, array lens, spherical lens, Fresnel lens and a combination thereof.

6. The food processing testing device according to claim 1, wherein the food under test is selected from an aged meat, seafood, cheese and a combination thereof.

7. A food processing testing method, comprising steps of:
emitting an acoustic wave signal to a food under test by using a testing apparatus;
reflecting an energy information of at least one corresponding reflected acoustic wave signal after the acoustic wave signal passes through the food under test;
performing an operation processing on a distribution of the energy information so as to generate a testing result.

8. The food processing testing method according to claim 7, wherein: at the step of performing the operation processing on the distribution of the energy information so as to generate the testing result, the energy information is transformed to be a gray-scale image, and the operation processing is performed based on a plurality of gray-scale value of the gray-scale image so as to generate the testing result, wherein the testing result comprises an aging status.

9. The food processing testing method according to claim 7, wherein: at the step of performing the operation processing on the distribution of the energy information so as to generate the testing result, the energy information, the testing result and an information of the food under test are processed by an artificial intelligence so that a predictive aging information is generated.

10. The food processing testing method according to claim 7, wherein the predictive aging information comprises an aging temperature value, an aging humidity value, an aging time, an air flowrate or a combination thereof.
